(19) United States
(12) Patent Application Publication
(10) Pub. No.: US 2018/0281916 A1
(43) Pub. Date: Oct. 4, 2018

(54) AN IMPROVED AIRSHIP

(71) Applicant: Christopher BETTS, Mount Dandenong, Victoria (AU)

(72) Inventor: Christopher BETTS, Mount Dandenong, Victoria (AU)

(21) Appl. No.: 15/525,067

(22) PCT Filed: Nov. 12, 2015
(86) PCT No.: PCT/AU2015/000686

§ 371 Date: May 7, 2017

(30) Foreign Application Priority Data
Nov. 14, 2014 (AU) 2014904575

(51) Int. Cl. B64B 1/14; B64B 1/26; B64B 1/36; B64B 1/38

(52) U.S. Cl. CPC B64B 1/14; B64B 1/26; B64B 1/70; B64B 1/38; B64B 1/36

(57) ABSTRACT

An airship in the shape of an annular aerofoil, designed so that the sides of the airship have a streamlined shape. Within the central passage is an efficient propulsion unit, the thrust from which is vectored to provide manoeuvrability.

### FIELD OF INVENTION

The present invention relates to lighter-than-air vehicles in general.

In one form, the invention relates to a lifting device, such as an airship in the shape of an annular aerofoil with accompanying structural, propulsive and aerodynamic features to enhance such a device for relatively higher speed operation, better manoeuvrability, and safe operation.

In one particular aspect the present invention is suitable for use as a relatively small ‘drone’ aircraft.

It will be convenient to hereinafter describe the invention in relation to an airship, however it should be appreciated that the present invention is not limited to that use only.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Despite their early promise, airships have not been able to compete with modern heavier-than-air craft, outside niche industries such as tourism. This is due to a number of major drawbacks. The energy cost of moving a large body through the air makes them uneconomic for cargo transport, while the large mass and relatively poor power (relative to their size) makes them difficult to manoeuvre both in the air and on the ground, leading to frequent accidents. Finally their large size and limited weight carrying capacity led historically to a relatively flimsy construction that left them very vulnerable to wind and storm damage.

However there remains active research in the area of airships, and their use is still considered for some applications. They may have a role to play as high altitude platforms, and the fact that they provide ‘free lift’ continues to attract inventors looking for novel cargo transport. Further, their large size, which in most respects is a drawback, makes them ideal for running on solar power.

Separately, there has been significant research, particularly in the late 1950s and 1960s, in the use of annular aerofoils (or ‘ducted fan flying platforms’), particularly for use in vertical take off and landing (VTOL) aircraft such as the French ‘Coléoptère’. However the weight of the ring, the power requirements of the vehicle, and the difficulty in manoeuvring the structure meant that despite their initial promise, they proved impractical compared to helicopters for VTOL heavier-than-air flight.

Airships with Internal Channels

A number of airships have attempted to overcome the problems of slowness and manoeuvrability by using internal channels within the airship such as:

Jordan (U.S. Pat. No. 2,475,786, 1949) proposes a long, thin tube within a conventional airship. The tube is comprised of successive ‘Venturi tube segments’ within which run multiple pairs of counter-rotating propellers. Additionally, Jordan has ‘angularly adjustable tube’ segments fore and aft to provide steering and control. But a succession of “Venturi tubes”, rather than having lower air resistance than a straight tube, in fact will have higher air resistance, and the numerous counter-rotating propellers will likewise be considered very inefficient. Overall the thin central tube would be impractical, have very high air resistance, and would need to be very strong to support sufficient thrust to move the airship. Further, the ‘adjustable tube’ aft would be relatively difficult and weighty to construct, while the forward inlet tube would have little effect, as one cannot steer by suction.

Gembe (U.S. Pat. No. 3,185,411, 1965) discloses a rigid elliptical airship split with a (viewed head on) rectangular mid section, into which there is a thin duct from front to rear. However the overall aerodynamics of the ‘high speed airship” are not optimised. Gembe's disclosure relates to a large ‘elliptical’ airship of unusual construction, particular dimensions, and with a custom gas buoyancy system. The long, thin internal duct is not considered aerodynamic, nor is there consideration of the overall streamlining of the airship and duct.

Takahashi et al, (U.S. Pat. No. 5,071,090, 1991) discloses an airship with a thin duct running from front to rear, with a number of side tunnels running from the central duct, to be used for fine manoeuvring control. However, similarly to Jordan ('786) and Gembe ('411), there is no attempt at overall aerodynamic efficiency, and the non-streamlined shape of these ducts would make driving air through them very inefficient. In general, placing engines in long thin ducts is not considered efficient.

Campbell (U.S. Pat. No. 5,645,248, 1997) proposes a sphere with a large internal tunnel, within which is mounted a hexagonal unit containing a propeller and control surfaces, with the object of creating a manoeuvrable, low-drag airship suitable for station keeping in high winds. However, despite Campbell's efforts to minimise drag, his sphere is intrinsically a high-drag shape, with significant turbulent flow (and accompanying drag) inevitable. Campbell's invention relates solely to a spherical airship, and uses external engines for manoeuvring.

Grimm (WO 2001072588, 2001) discloses another “nozzle shaped” airship with a central duct. In many aspects the design is considered impractical as there is no consideration of airflow separation or the changes in overall shape required for different operational regimes.

Drucker (U.S. Pat. No. 7,669,82, 2004), discloses an airship with a duct from front to rear (like Campbell '248), into which there is placed a wind turbine to generate energy. Drucker discloses generating energy from the craft by floating with the wind, but such a mechanism is not possible, as an unpowered airship will float at the same speed as the wind, and there will be no differential airflow.

Motts, (U.S. Pat. No. 4,967,983, 1990) discloses another airship with a relatively complex arrangement of internal cones and braces, and the feature of “electrokinetic propulsion”. It is not considered practical to construct.

### Aerodynamic Efficiency

The inventor has realised that a reason for the inefficiency of airships as practical aircraft is the very high drag caused by moving a large ovaloid shape through the air. Some of this drag is caused by protruding structures or surface roughness, while a significant source of drag, particularly in smaller airships, is caused by the ‘form drag’, or turbulent wake behind the airship, which is intrinsic to the shape of the vehicle.

A number of inventions have attempted to reduce the drag by active airflow control to maintain laminar airflow for longer, and to remove the risk of airflow separation; e.g. by sucking air in at the rear of the vehicle, but there are significant practical difficulties in trying to do this in a traditional airship as it may require a great deal of tubing and pumps. (E.g. Onda U.S. Pat. No. 6,305,641 who sucks air in at the back via a duct, Colting U.S. Pat. No. 6,966,523 who tries to use a rear propeller to control air flow around a spherical ship, or Herlik in U.S. Pat. No. 8,052,082 who sucks air through the rear surface of the ship via a system of intakes). An underlying difficulty with all these systems is that the weight of the ducts, pipes and particularly the powerful engines required, make such systems very difficult to build in practical airships.

### Wind Turbines

The inventor has also realised that unlike powered airships, floating tethered wind turbines with internal ducts have proven quite practical, and are beginning to be seen in active use for energy generation. A good example of the art is Amick (US2008/0048453, 2008) who discloses a floating funnel into which is placed a wind turbine for power generation.

As the floating wind turbine is tethered, streamlining of the shroud is far less important than the ability to funnel air into the central blades, and despite the efforts of streamlining, the squat funnel shape of the shroud is likely to have significant turbulent drag behind it. Meanwhile this shape is optimised for the purpose of providing positive lift for the turbine and concentrating airflow, and while some attempt at streamlining is made, the overall shape of the device would have significant drag in high winds due to the steep angles and rounded contours at the back of the device.

### SUMMARY OF INVENTION

An object of the present invention is to provide an improved airship.

A further object of the embodiments described herein to overcome or alleviate at least one of the above noted drawbacks of related art systems or to at least provide a useful alternative to related art systems.

In a first aspect of embodiments described herein there is provided a lighter-than-air vehicle built in the shape of an annular aerofoil, the cross section having a rounded leading edge and relatively sharp trailing edge. Within the central duct of this aerofoil is placed an optimised propulsion system, which may take advantage of either or both of the increased airflow, and the ‘ducted fan’ topology of the overall shape of the airship envelope. The central location of the engine has both structural and safety advantages. Further, the outlet airflow can be controlled to create ‘vectored thrust’ to manoeuvre the airship, optionally in conjunction with other control surfaces.

In another aspect of embodiments described herein there is provided an airship having a body portion and propulsion mechanism, the body portion comprising a relative annular duct through which air can flow, and further comprising a relatively aerofoil shape in cross section, and the propulsion mechanism being provided within the duct.

Other aspects and preferred forms are disclosed in the specification and/or defined in the appended claims, forming a part of the description of the invention.

In essence, embodiments of the present invention stem from the realization that although some of the prior art considers the use of an internal tube, such prior art does not consider the actual airflow through and around what is basically a large ducted fan. In particular there has been little consideration of the advantages of using an aerofoil cross-section around such a fan. The inventor has realised that ducted fans operate most efficiently when clad in an aerofoil cross section (that is to say a smooth shape that encourages laminar flow, having a somewhat teardrop shape with a generally rounded front end and a tapered back end—a classic ‘aircraft wing’). Without this shape significantly higher drag is likely to be experienced both within the duct and externally, largely due to airflow turbulence. Further, there appears to have been no consideration in prior art of the size ratios between inlet, rotor disk and outlet, and the differences required to optimise craft of different sizes for different environments.

With this in mind, the present inventor has realised that an airship can be provided which has a body portion having a relative annular duct through which air can flow, and a relatively aerofoil shape in cross section, and providing a propulsion mechanism within the duct.

Advantages provided by the present invention comprise the following:

Reduced drag due to the annular shape, particularly in smaller airships.

Improved engine efficiency

Significant reduction in the number of external protrusions, e.g. removal of externally mounted engines, control surfaces may be smaller or removed altogether, there is no need for external guy lines etc.

Instrument packages, or even crew cabins, can be incorporated into the curve of the leading edge of the annulus, which may provide excellent forward visibility (as opposed to traditional designs where they must protrude to provide a decent field of view).

The airship can be easily built to use vectored thrust, as the exhaust airflow may be modified either with internal vanes, steering fans or jets embedded in the trailing edge, or (especially with small drones) gross deformation of the trailing edge of the annulus.

Enclosing the engines makes the airship significantly safer at all scales, as there are no exposed propellers. Additionally, in-flight maintenance on large airships becomes safer as the engines are easily and safely accessed via the central tunnel.

The noise of the engines is significantly reduced, as the envelope encloses the engine.

The manoeuvrability of the airship is improved by having the weight of the engine close to the centre of lift, making the airship easier to rotate, as well as preventing the off-axis thrust which causes traditional airships to pitch up under power

The ducted fan layout, with the large intake, brings additional advantages as it concentrates a large volume of air, allowing the engine (such as a propeller) to act as if it was proportionally larger. This brings efficiencies at lower altitudes (a large, slow propeller is, all things being equal, more efficient than a small, fast propeller) and may also allow the use of air-breathing engines such as a traditional combustion engine at higher altitudes, where the thin air would normally make operation difficult.

The larger surface area of the airship (compared to a normal airship of equivalent lift) gives it a greater surface for the collection of solar power.

When used as a drone aircraft, the airship is relatively neutrally buoyant, and generally ‘fails safe’ if there is a loss of control. Unlike rotorcraft, human impact with the airship is unlikely to cause injury, as without power the device is effectively a large balloon

The low pressure exhaust allows for active boundary layer control, by running channels through the body of the airship from the exhaust channel to the outside skin to suck in small amounts of air. While this decreases overall power, under some circumstances it can reduce both skin and form drag to provide an overall energy saving.

New and novel manoeuvres are possible compared to a traditional airship. As the weight of the engine is close to the centre of lift, the airship can ‘loop the loop’ and is generally far more manoeuvrable, having a lower moment of inertia than a traditional airship with external engines.

When used as a small drone, the airship can attach to flat surfaces such as walls or ceiling by mild suction, allowing it to keep a stable position (e.g. as a camera platform) with low power expenditure.

Throughout the specification, the word ‘airship’ refers to what is know as a ‘lighter than air’ device adapted to travel or manoeuvre in air. For example, the device may be a lighter-than-air aircraft having propulsion and steering systems, and/or a device operable to move or travel in air. In one form, the airship according to embodiments of the present invention may be a tube like shaped or annular shaped device which can be made to travel in air.

Throughout the specification, the word ‘aerofoil’ refers to a ‘low drag object with a design which will seek to minimise drag and/or a smooth shape that encourages laminar air flow and/or reduces turbulence. An example of an aerofoil, without limitation includes an object which will have features like a rounded leading edge and a tapered trailing edge, and will have relatively smooth curves to minimise drag.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates an overview of a generic annular aerofoil airship

FIG. 101 illustrates a side profile of the annular wing design.

FIG. 102 illustrates the rear of the annular wing with an interior engine.

FIG. 103 illustrates the annular ring with two counter-rotating engines to smooth airflow.

FIG. 104 illustrates a cross-section of the airship.

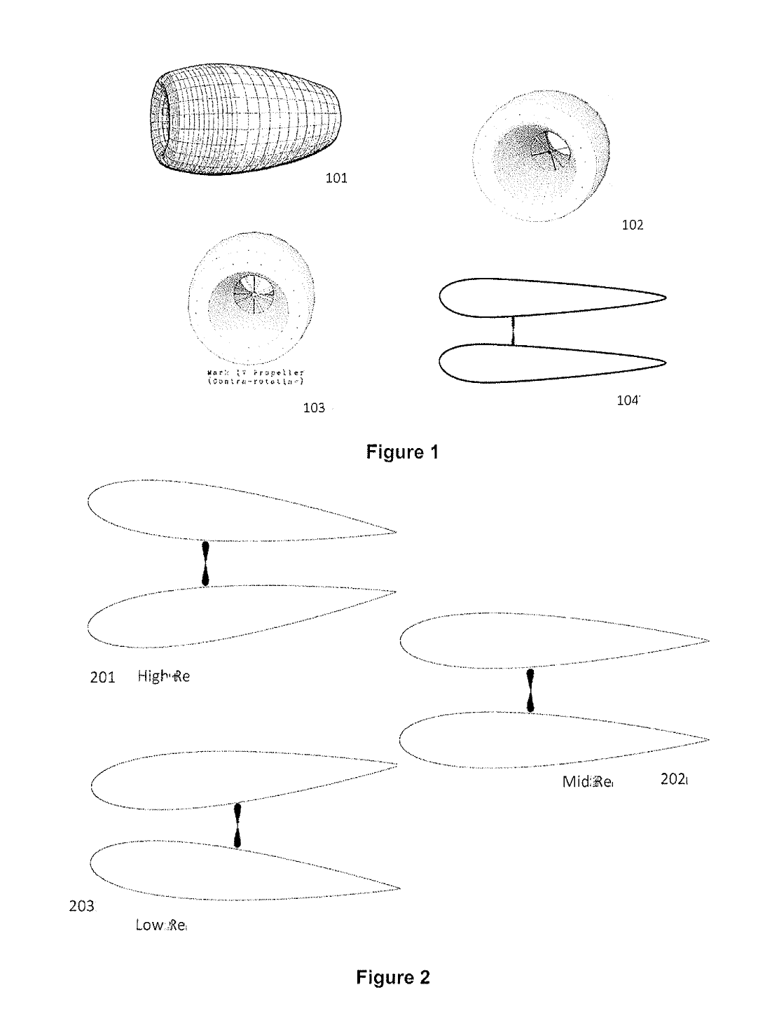

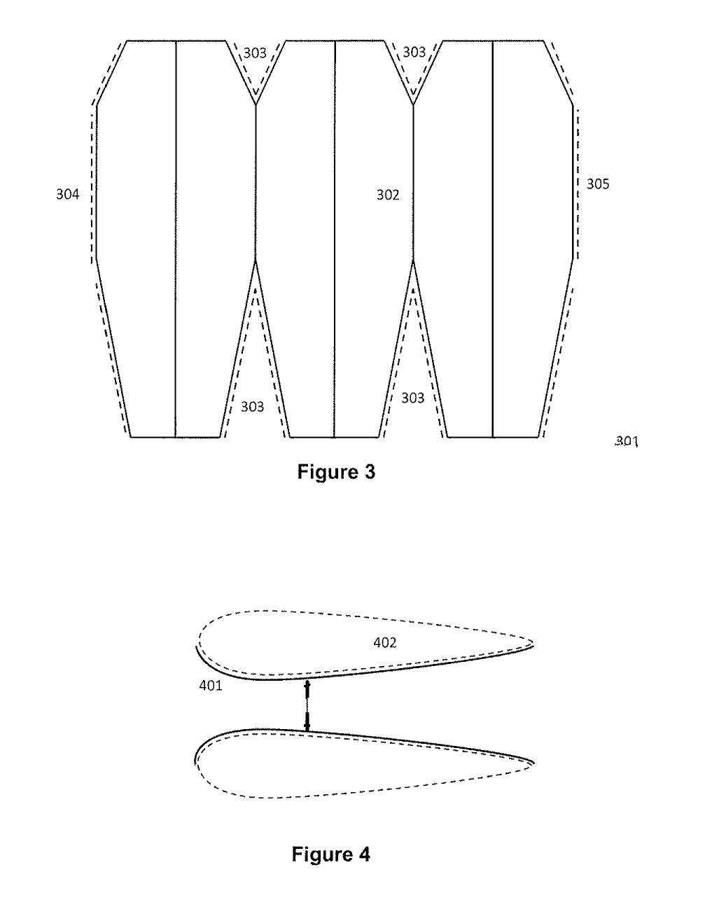

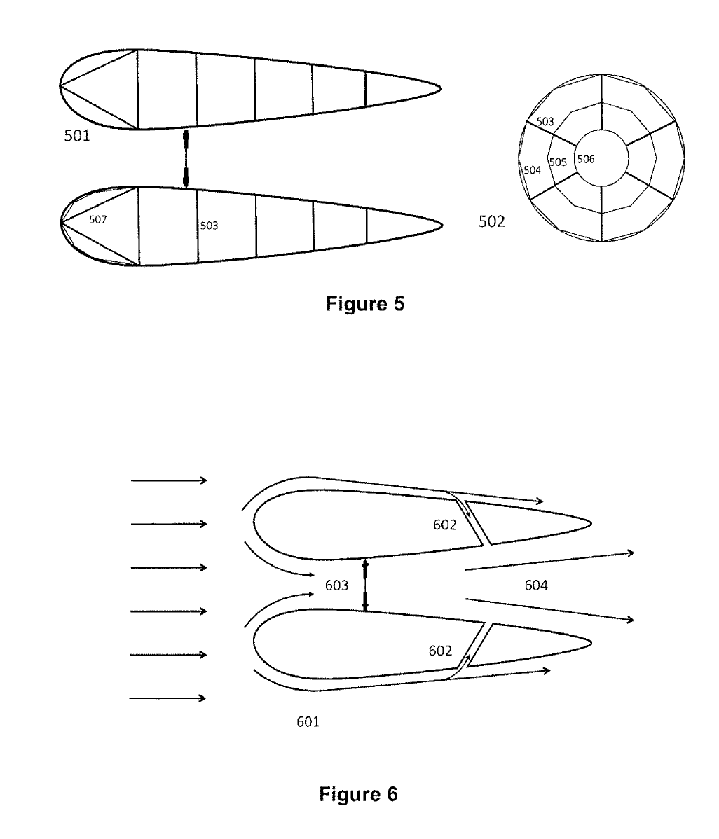

FIG. 2 illustrates an example of a small, medium and large airship configuration.

FIG. 201 illustrates an example of an airship configuration for operating at high Reynolds numbers (e.g. large airships). In these conditions boundary layer separation and turbulent flow is a serious issue for the central duct, which is largely parallel to maintain engine efficiency.

FIG. 202 illustrates an example of a design for medium Reynolds number ranges as might be encountered by a large drone airship or stratospheric airship. The ducted fan engine can take advantage of the lower Reynolds numbers by flaring the exhaust flow, increasing the diffusion ratio.

FIG. 203 illustrates an example of a design for a low Reynolds number as a small drone might encounter. At this scale a widely flared exhaust flow allows for optimal momentum transfer to the exhaust airflow and engine efficiencies can be over twice that of an unsheathed propeller of the same size.

FIG. 3 illustrates an example of small relatively ‘non-rigid’ airship formed from heat-sealable cells

FIG. 301 illustrates an example of a non-rigid airship constructed from a double layer of heat sealable gas impermeable plastic (such as EVOH or metallised nylon). The black lines are heat sealed together to create gas cells and the shape cut out from the base along the dotted lines (303), as well as being trimmed top and bottom.

The cells stay joined along the common vertical lines (302). The cut seams (303) are then joined to their adjacent seam, and then the left side (304) is joined to the right side (305) before being inflated (by valves sealed into each cell, not shown).

FIG. 4 illustrates an example of a relatively semi-rigid airship

A semi-rigid design may be constructed by creating a stiff inner duct (401) and then attaching either a series of tubular balloons (402) or a single large envelope (not shown) to create a semi-rigid, optionally expandable outer envelope with a solid supporting duct as a ‘keel’ to the vessel to attach an engine and equipment.

FIG. 5 illustrates an example of a relatively rigid airship

A rigid airship can be constructed along traditional lines with rigid reinforcing to give the envelope a defined shape. As an example of such construction, an airship can have an inner duct created from a series of circles (506) joined with longitudinal lengths, with further struts (503) radiating out from the central duct circles to a set of members (504) that define the shape of the outer surface. Additional rigidity can be provided to the leading edge surfaces by bracing the leading edge with members (505) that are in turn supported by beams (507).

FIG. 6 illustrates an example of boundary Layer control

The annular aerofoil airship ingests air into the duct engine (603), which expels it to the rear (604) adding velocity/momentum. This causes a significant pressure drop in the region (604) allowing us to run small tubes (602) to the exterior surface of the airship. These can draw in a small amount of air to assist the external air stream (605) to remain ‘attached’ to the body of the airship, thus delaying or preventing the formation of a turbulent wake and avoiding the significant drag such a wake creates. While only two tubes are shown for clarity a large number are desirable, and the tubes may ‘fan out’ so that a single outlet in the engine wake corresponds to a number of small inlets or even a continuous ring inlet on the exterior of the airship.

### DETAILED DESCRIPTION

Airships are speed limited by the power required to overcome the drag of the airship. In general the power required is proportional to the cube of the velocity multiplied by the drag of the airship. For this reason it is highly advantageous in practical airships to reduce the drag as far as possible. This invention attempts to decrease the drag significantly, while also offering improvements in power and handling.

### Aerodynamic Efficiency

This invention reduces the drag of the airship by giving it a streamlined cross section to reduce drag. A traditional low-drag aerofoil shape, with a rounded leading edge and sharp trailing edge, as is already used in general aviation for sub-sonic wings, propellers and struts, and is described in catalogues such as the various “NACA aerofoil series” is used. As there is usually no requirement to produce lift the cross section of the annulus will generally be in the shape of a symmetric aerofoil with no significant camber. (Although an annular aerofoil can be made into a lifting body if desired, either be flying at an angle, or by varying the camber of the top, bottom and sides of the ring.) A similar effect could be created by making the airship into a long ‘flying wing’, but such a shape would have many disadvantages (it would have a high surface area to volume, be difficulty to control, and would be inconvenient to handle on the ground).

By ‘wrapping’ such a wing into an annular aerofoil however, we achieve many advantages. The surface area to volume is improved (although still significantly worse than a conventional airship), and an internal cavity is created that is very suitable for mounting an engine.

The overall shape of the annular aerofoil significantly reduces the turbulent wake of the airship, while the shape of rear duct can be designed to match the optimally efficient engine outlet flow in the desired operational range (e.g. wide for a small, low flying airship, or narrower for a larger airship).

The annular aerofoil shape, combined with a generally central engine and a combination of vectored thrust and/or smaller control surfaces, and instruments and payload incorporated into the hull, further dramatically decreases the parasitic drag of external engine mountings and large fins. Further, the shape makes flights at higher altitude practical, both by reducing the overall drag, and by concentrating airflow to the engine, allowing air breathing engines to operate at higher altitudes.

Note that it is occasionally advantageous to deviate from the exact shape of an ‘ideal’ aerofoil, especially with smaller, non-rigid models where the sharp trailing edges of traditional aerofoils may be difficult or heavy to construct. This may require ‘rounding off’ the trailing edge (and accepting a corresponding degree of turbulent drag).

### Engine Advantages

Placing the engine within the annular aerofoil has many advantages.

The central location minimises the angular moment of the airship, making it easier to manoeuvre. Having the engine at or close to the axis of the airship allows for the thrust of the engine to be through the centre of the airship, preventing the offset forces that cause traditional airships to change attitude depending on engine power.

Central placement also reduces the weight requirements of the airship, as there is no need for external bracing to bear the weight of engines on the outside of the envelope. Further, the thrust of the engines can be more evenly distributed to the rest of airship via the central duct (which is made stiff, either by reinforcement in the rigid or semi-rigid case, or by the pressure of multiple airbags in the non-rigid case).

The concentration of air into the engine inlet is useful in two ways; first it allows for more efficient operation of an air-breathing engine as the air will generally be denser in the inlet once the airship is moving relative to the air. This ‘ram air’ effect acts similarly to a super-charger or turbo-charger in a car engine, allowing for a denser fuel-air mix to be fed to the engine. Secondly the increased airflow is more effective for an engine propeller, and allows for a larger mass of air to be moved by a given size of propeller.

Additionally, the relatively slow airspeed of the airship compared to heavier-than-air aircraft allows for the use of larger, slower, but more efficient, propellers bringing additional energy savings. These advantages are shared both by combustion driven and electrical/solar-powered engines, and make the aircraft more efficient for both combustion engines and solar power than a traditional airship.'

The primary advantage of mounting the engine within the annular aerofoil however comes from the ‘ducted fan’ or ‘shrouded fan’ effect. While it is well known in the literature that a shroud can improve the efficiency of a propeller of given size by a factor of two or more, the size and weight of the shroud generally makes such arrangements impractical (although they are seen in small rotorcraft and occasionally in experimental aircraft). In the case of the annular aerofoil airship however the shroud comes ‘for free’ as it is used as the lifting body of the airship.

### Duct Efficiency

Ducted fans have become popular for small UAV rotor craft, however the designs used are heavily influenced by the need to minimise the overall weight of the shroud, and by the off-angle usage in heavier-than-air craft (e.g. ducted fan engines are often effectively flown sideways in small drones). In the case of the airship we have the opposite problem; we want to make the volume of the shroud as large as possible while minimising overall drag and preventing or minimising flow separation and turbulence both within the duct and externally. Further, the duct is being used in an optimal ‘front facing’ configuration, rather than at significant angle to airflow as used in small drone rotorcraft (where at low speeds bluff body drag can account for up to 95% of drag, as the shroud is pushed sideways through the air).

Other inventions that have considered airships with internal engines within ducts have ignored the detail of both ducted fan design and the cross-sectional aerofoil shape of the envelope, and usually specify either a long, thin, straight tube, or an equal funnel shape both front and back.

However there are a number of engineering parameters that must be balanced, and generally (without actively changing the shape of the airship in flight) it is necessary to select an optimal cruising speed and optimise both the length of the airship and shape and ratios of the inlet radius, the rotor disk, and the outlet radius.

These figures are very different for small airships compared to large airships. As an example, a large airship travelling at half the speed of sound, with inlet and outlet diameter roughly twice that of the rotor disk (as presented in Grimm '588 above) presents serious problems, as the four-fold concentration of air into the front gives rise to supersonic flows within the airship, followed by significant flow separation in the outlet channel, and in fact such an airship as presented is highly impractical.

In general, a large, rounded inlet is desirable at almost all practical scales and speeds, while the size of the rotor disk and outlet channel (and the diffuser ratio of their relative sizes) must be tuned to the size and speed of the airship. The limitation is largely around flow separation downstream of the rotor disk, which is heavily dependent on Reynolds number. In general, small, low speed airships can benefit from a large diffuser ratio (e.g. a widely flared outlet channel) while larger or higher speed airships will need that ratio narrowed to a limit approaching 1 (e.g. a cylindrical outlet for very large, high speed airships). (See FIG. 2)

Even in the limiting case of a straight outflow there are still power advantages, as the larger inlet and reduced propeller tip turbulence still provide for more efficient operation, and the outflow is still larger than the natural jetstream of an open propeller, where the airflow diameter contracts significantly from the size of the rotor disk as it equalises pressure with the surrounding air.

Other principles that must be considered during design are:
Disk loading: low disk loading (e.g. the amount of air ‘pushed’ by a given area of a propeller) is more efficient, so designs favour a large rotor in a large duct.
The inlet size allows the rotor to effectively act as if it were much larger (e.g. theoretically the size of the airship inlet)—so a large inlet is advantageous.
The inlet size should not be so large as to risk supersonic flow within the duct, and ideally should avoid supersonic propeller tip effects
The ratio of inlet size to rotor disk must not be so great as to ‘choke’ the flow and create significant back-pressure, which would negate the advantage of the overall annular aerofoil profile.
The advantages of a proportionally larger duct and rotor must be balanced against the increased weight of the propeller, the increased wetted area of the airship, and the corresponding reduction in airship volume.
Engineering intuition generally places the rotor disk at the narrowest portion of the duct, however this is not always the optimal position when considering the overall drag of the craft. Minimising the overall curvature (and hence drag) of the exterior of the craft while extending the length of laminar flow in the interior duct may lead to the rotor disk being placed further back in the duct, after the duct has started expanding. Similarly, the shape of the exhaust volume of the duct may deviate from a classic 2D aerofoil shape (and flatten out) in order to minimise downstream turbulent flow.

Similarly, the engine may need to be offset from the narrowest portion of the duct for reasons of stability and overall weight balance.

### Safety

A significant issue hindering the wider use of commercial drones (such as quadcopters and other heavier-than-air remote aircraft) is concern around safety, particularly when these drones are operated close to humans—for example there have been cases of injuries at sporting events caused by drones colliding with competitors. These cases can be serious, as the rotors of many drones are often un-protected, or even if shrouded may still catch fingers and loose clothing. The risk becomes greater the larger the drone, as the actual impact of a larger drone falling or travelling at speed may itself may cause significant injury.

However the present invention effectively hides the engine within a large air bag, making small drone versions of the invention safe for usage close to people. If further safety measures are desired, the duct openings may be additionally protected with a mesh or other obstruction to prevent limbs or other objects coming into contact with the engine.

In addition, as the airship is generally neutrally buoyant, if it loses power it will simply drift and eventually deflate, rather than falling and causing injury.

On larger vessels, the central placement of the engine makes in-flight maintenance and repair more practical as well as preventing accidental damage from external engines colliding with structures during ground handling.

### Structural Advantages

Locating the engine at or close to the centre of gravity (or more accurately, ‘centre of lift’) has many mechanical advantages. Unlike traditional airships, the engine or engines do not requires significant bracing on the side of the aircraft, and thrust from the engine does not cause the airship to change attitude. Internalising the engine also allows us to dispense or minimise high drag structures such as engine bracing and guy lines, and makes it easier to distribute the thrust of the engine more evenly to the body of the airship.

The design also solves a problem with airship control surfaces. Traditionally airship control surfaces (the fins at the back of the airship) must be made very large, in part because the base of the fins is generally within turbulent air caused by the ‘wash’ of the back of the airships ellipsoidal shape. The control surfaces of a traditional airship must be made large, in part to extend out to reach ‘clean’ air where the control surface can be more effective.

However the annular aerofoil shape of the gas envelope minimises both the turbulent wash behind the aircraft and the distance to ‘clean air’, and hence control surfaces can be made smaller, reducing both cost and overall drag. Further, the use of thrust vectoring (which may in turn also require control surfaces internal to the duct, depending on the method used) also reduces the overall surface area of control surfaces required, similarly reducing drag.

Overall, the annular aerofoil shape has a significantly larger ‘wetted area’ than the equivalent traditional airship, and hence higher skin friction drag—the wetted area of prototypes is frequently 25-33% greater than the equivalent traditional ‘football’ shape of the same volume. However it more than recovers this extra drag through significantly reducing form drag and eliminating or greatly reducing the parasitic drag of engines, lines, cabins and control surfaces.

### Manoeuvrability

The central placement of the engine reduces the angular moment of the airship. Combined with the ability to vector thrust from the rear of the airship, or use fans mounted in the trailing edge, this allows the airship to turn significantly more easily, including at low speeds. This is particularly important for small drone airships and provides a simple and cost-effective means for controlling small craft without additional control surfaces, extra steering engines and so on.

### Solar Power

As discussed, the design of the annular aerofoil airship has a larger surface area to volume than a traditional airship.

There is one direct advantage however of the larger surface though, in that the airship provides an excellent platform for solar power collection (airship solar power collection in general has been frequently described in prior art). Given the reduced power requirements of the more efficient airship, the increased collection area allows for practical solar airship operation.

### Boundary Layer Control

As mentioned previously, a key requirement for airships is to reduce the drag. The annular aerofoil shape reduces the drag significantly by preventing or delaying boundary layer separation and the accompanying turbulent wake common to traditional airships.

A number of other inventions have attempted to improve airship drag through ‘active’ boundary layer control, sucking air in at the rear of the airship to maintain airflow attachment. (E.g. Goldshmeid. Integrated Hull Design, Boundary-Layer Control, and Propulsion of Submerged Bodies, Second Propulsion Joint Specialist Conference, Colorado Springs, Colo., 1966).

Such inventions have usually failed to realise practical benefits however due to the extra weight of equipment and complex flow geometry. However with the annular aerofoil airship the air flow in the exit tube is at significantly lower pressure than the surrounding air, and it is possible to suck a small amount of air (and hence aid boundary layer attachment, or at least delay separation) simply by making small openings towards the back of the airship [FIG 6]. As this requires no extra equipment or weight (other than that of the tubes or ducts), this method can be practically used to reduce drag when the airship is operating under conditions where it would be of benefit (e.g. at speeds and altitudes where there would otherwise be significant separation and wake turbulence).

### Operating Concept

The invention envisions three broad operational modes.

The first operating concept is that of a small, lightweight drone airship, generally less than 2.5 m in length and less than 1 m in diameter, with a payload of less than 500 g, for use as either a toy or a safe, lightweight drone. The airship would have a longer endurance than rotorcraft drones, especially in light wind or no wind conditions, but would have a relatively slow speed compared to other drone aircraft types. The drone would use a simplified steering system combining one or more elements of vectored thrust, steering fans, weight transfer and/or traditional fins, and would usually be of non-rigid construction. In some circumstances the drone could use the suction of the engine to ‘stick’ to surfaces (including the ground and walls) to anchor itself by either the nose or the tail.

The second operating concept is that of a standard crew carrying airship, of rigid or semi-rigid construction, with a forward cabin, a generally central engine, and fuel, batteries and other equipment distributed as required for balance.

The third operating concept is that of a high altitude airship of semi-rigid construction, with the central duct made of a lightweight material such as carbon fibre containing the engine, with flexible tubular balloons attached to the rigid duct. As the airship ascends to, say, 50,000 feet (where air pressure is ˜10% of that at the ground) the airship would be able to retain its general shape, and the rigid central duct would allow both for efficient engine operation and general control of the airship.

First Embodiment

The first embodiment of my invention concerns a streamlined airship with a large central duct, shaped in the form of an annular aerofoil to minimise overall drag.

FIG. 104. is a side view illustrating the general shape in cross section. The ‘sides’ of the airship are chosen to have the streamlined cross section of an aerofoil.

Within the duct is an engine, such as a propeller. A propeller has many advantages in this configuration, as it may operate more efficiently due to the reduced tip turbulence from operating within a ‘shroud’, and benefit from the increased airflow of the large forward opening. Additionally, as airships generally operate at lower speeds than aircraft, a larger, slower, but more efficient propeller may be used, and may be designed to provide thrust along its entire length (as opposed to traditional propellers which ‘flatten out’ near their tips to reduce turbulence).

Finally, the front of the airship will concentrate air into the central chamber, providing higher forward air pressure and further engine efficiencies (including denser air for combustion engines).

### Rigid, Semi-rigid and Non-rigid Embodiments

Manufacturing a stable envelope shape presents some challenges, as an elongated circular shape of this sort cannot simply be made out of rubber and inflated, as the inner duct will close up as the airship expands into an approximation of a sphere. Additionally the channel downstream of the engine must cope with the significant pressure drop caused by the flow of air accelerated from the engine. A number of methods can be used to maintain the shape of the airship and the central channel, and which method is appropriate depends largely on the size, stress, cost and operational environment intended for the airship.

A Non-rigid Design

A non-rigid design suitable for small drones in relatively light conditions such as use within office buildings, inside trade shows or as a toy can be created by building the airship from a number of non-stretchable, inflatable, longitudinal tubes or cells. These cells may be pressed out of any of the common heat-sealable impermeable fabrics in common use, including EVOH, poly-urethane and aluminised nylon (See FIG. 3). The cells are then attached to each other to create a close approximation of the desired aerofoil shape, the inner duct being kept open due to the pressure of the sidewalls of the cells.

In one specific embodiment, six such cells are pressed out of a common sheet, and the shape is adjusted slightly to include a straight section joining pairs of cells. The remainder of the shape is joined (usually with thermal tape) along the common seam line, and a final join is made between the first and last cell creating the ring aerofoil.

In this embodiment, suitable for small lightweight drones and toys, there is an irregularity in the internal duct (caused by the ‘bulge’ of the cells) that requires a light internal shroud for the propeller, which both acts to shape the airflow and protect the fragile fabric of the duct from the propeller tips. This internal shroud may be made from any light material, but both polystyrene and light plastic have proved practical.

Directional control can be created either by external fins, fans embedded in the trailing edge, or by vectored thrust. In the simplest form, vectored thrust is created by tugging on the fabric of the exit ring of the central duct with guy lines thus deforming the exit ‘nozzle’ of the airship, or by a combination of this method and traditional fins. (In small drones attitude control may also be effected by weight transfer, e.g. by moving a battery pack along a light plastic track.)

### A Semi-rigid Design

A semi-rigid design suitable for larger drones and heavier wind conditions, and possibly high altitude use, can be created by strengthening the inner duct to create a hollow ‘spine’ for the airship, from which gas bags (possibly tubular, as in the non-rigid example above) can be attached. (See FIG. 4)

In this embodiment, the gas bags themselves may be made from a more flexible material, and may be allowed to expand and contract as the vehicle rises and falls, without compromising the shape and efficiency of the central duct and engine.

Alternatively a single large inflatable envelope may be used, centred on the spine, and significantly reducing the amount of fabric required for the envelope.

The increased rigidity of the central spine may be extended to create a fairing for the front of the airship, to improve aerodynamics of the airship and to reduce ‘flutter’ when the tubes are under-inflated (e.g. during the early stages of launch of a high flying airship, before reaching flight altitude)

### A Rigid Design

For large airships or airships operating under strong wind conditions a traditional rigid construction may be used, with a supporting grid of members providing shape both to the external envelope and the internal duct. (See FIG. 5)

The supporting ‘skeleton’ of the ship must be built to take into account the low pressures found in the exhaust section of the internal duct.

The overall balance of airship components must be taken into account; generally the cabin will be forward, the engine centred, and fuel, batteries and equipment at the rear. However the position of these elements may be moved to provide overall balance in the design, or to optimise airflow under different design regimes (e.g. the shape of the aerofoil and position of the engine is different for a small, low flying airship compared to a large, high flying airship).

A rigid design may also be of use in smaller drone airships, where the supporting members may be made of a lightweight plastic, such as polystyrene or aerogel, or a carbon fibre mesh. Sheets of polystyrene shaped into an aerofoil with internal sections cut out can be combined with the non-rigid or semi-rigid designs above to give them extra stability.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. An airship adapted to operate as a lighter than air device having a body portion, the body portion comprising a relative annular duct through which air can flow, and further comprising a relatively aerofoil shape in cross section.

2. The airship of claim 1, further comprising a propulsion mechanism, the propulsion mechanism being provided within the duct.

3. The airship of claim 2, wherein the propulsion mechanism is an engine utilising a propeller relatively closely fitted to the walls of the duct to reduce turbulence and improve efficiency.

4. The airship of claim 3, wherein the engine utilises counter-rotating propellers to reduce torque and smooth the airflow.

5. The airship of claim 3, further comprising a steering mechanism adapted to direct outlet airflow from the engine to provide vectored thrust for the purpose of steering or assisting in the steering of said aircraft.

6. The airship of claim 5, where active weight control is used to adjust the pitch attitude of the craft, and the motor, fuel, batteries, or some other form of ballast, is shifted fore or aft to pitch the craft down or up.

7. The airship of claim 1, where the shape of the outlet duct, and the diffuser ratio of the engine ‘rotor disk’ and the outlet, is optimised in accordance with a Reynolds number range.

8. The airship of claim 3, where the propeller is powered by a combustion engine.

9. The airship of claim 3, where the propeller is powered by an electrical engine.

10. The airship of claim 9, where the propeller is powered by a electrical engine, with some or all of the electrical power being generated by solar energy.

11. The airship of claim 1, wherein the body portion comprises one or more cells formed from a double layer of heat-sealable, gas impermeable material.

12. The airship of claim 1, wherein the body portion, in cross section, is formed of one or more aerofoil shaped cells.

13. The airship of claim 12, wherein the body portion is enclosed in an envelope defining the shape of the body portion.

14. The airship of claim 11, wherein the annular aerofoil shape is made of six tubular cells.

15. The airship of claim 1, wherein the duct comprises a central shaped hollow spine.

16. The airship of claim 14, where the annular aerofoil is constructed from a plurality of expandable tubular balloons attached to the central shaped hollow spine, optionally enclosed within a flexible external envelope providing further shape.

17. The airship claim 1, wherein the body portion is constructed fully or partially from a rigid framework defining the shape of the airship and providing support for equipment and/or crew.

18. The airship of claim 17, wherein the body portion is created by a series of shaped panels made from a lightweight material such as polystyrene, suitable for small drone aircraft.

19. The airship of claim 17, wherein the supporting structure of the airship is created by metal, carbon fibre mesh or strong plastic members suitable for large airship rigidity and the support of crew and equipment modules.

20. The airship of claim 1, further comprising one or more vents adapted to provide a degree of boundary layer control on the external airflow by opening channels to lower pressure of the central outflow duct.

21. The airship of claim 1, wherein the size of either or both of the inlet and/or outlet of the duct are dynamically adjustable during flight to change flight characteristics.

22. In combination, a plurality of airships as claimed in claim 2, and wherein manoeuvrability is accomplished by differential thrust from each propulsion mechanism.

23. A method of configuring an airship, the method comprising the steps of:
providing a body portion and a propulsion mechanism,
providing, in the body portion, a relative annular duct through which air can flow, the body portion having a relatively aerofoil shape in cross section, and
providing the propulsion mechanism within the duct.
